(19) United States
(12) Patent Application Publication
(10) Pub. No.: US 2018/0233037 A1
(43) Pub. Date: Aug. 16, 2018

(54) Traffic Signal 2D-Jam-Relief Control Mode

(71) Applicant: Weiping Meng, Flushing, NY (US)

(72) Inventor: Weiping Meng, Flushing, NY (US)

(21) Appl. No.: 15/891,283

(22) Filed: Feb. 7, 2018

(30) Foreign Application Priority Data
Feb. 8, 2017 (CN) 201710069293.2

(51) Int. Cl. G08G 1/01; G08G 1/07

(52) U.S. Cl. CPC G08G 1/0145; G08G 1/07

(57) ABSTRACT

The invention relates to a traffic signal mode field, discloses a method for a greenwave mode of traffic signal control that can relieve jammed traffic in 2 cross directions in a roadnet, the control method comprises the following steps: 1) calculating and allocating of RATIO mode with obtaining the jammed vehicle queue start-time of road-segments; 2) calculating and allocating of the 2D-Jam-Relief greenwave time-offset; run RATIO after the 2D-Jam-Relief greenwave time-offset runs out. The present invention shows that 2D-Jam-Relief greenwave signals mode obtains higher efficient by 50% in relieving heavy traffic jam in a roadnet than 1D-Jam-Relief greenwave mode, by 100% than mode RATIO, greatly improve the efficiency of traffic signal control and traffic.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates generally to a method for traffic control, particularly to a method for traffic Jam-Relief in 2 crossing direction in a roadnet.

Currently the most common traffic control method for road network are: RATIO and GREENWAVE. RATIO makes traffic get permit/stop based on the ratio periodically, where the maximum distance of each permit for traffic to move is permit-time multiplied by the set-driving-speed. GREENWAVE partially solves the problem. GREENWAVE greatly decreases the wait-time of the vehicles moving in same traffic direction as the greenwave direction; both directions should be parallel. 2-cross-direction GREENWAVE Lead mode is proposed, and also a traffic Jam-Relief mode in a reverse direction of traffic direction has been filed recently. If traffic jam in a cross direction over the previous traffic Jam-Relief mode direction in a roadnet can also be relieved, then the efficiency of traffic Jam-Relief would be improved further and traffic wait-time would be less.

### BRIEF SUMMARY OF THE INVENTION

It is an object of the present invention to realize traffic Jam-Relief greenwave in 2-cross-direction in a roadnet, so as to further expand the effectiveness of traffic congestion relief, decrease traffic wait-time, improve the efficiency of traffic and traffic control.

The main idea of the present invention providing a solution to achieve the above object is, configure all the channels in a direction in a roadnet as traffic Jam-Relief control mode and further change the time-offset of the source-intersections of the channels from the same values to the time-offset in the order of the source-intersections in a cross direction over the Jam-Relief mode direction, the time-offset are calculated also based on a traffic Jam-Relief channel, so that forms 2-cross-direction traffic Jam-Relief in a roadnet. The features of the present invention is as follow:

A method for 2-cross-direction traffic jam-relief greenwave mode in roadnets includes steps:

S1: Initialize signal system as mode RATIO with obtaining the feature parameters of a controlled roadnet, such as a rectangle area of M*N intersections, M columns of D-channels, N rows of D-channels, and the start-time of the jam-vehicle-queues of the road-segments of the D-channels of roadnet, denoted by JVQ-start-time, where the JVQ-start-time equals to JVQ-start-coefficient*queue-length, wherein the JVQ-start-coefficient ranges from 0.14 to 0.22, taking median 0.18, unit: sec/meter, can be dynamically adjustable with the control system;

S2 calculate and configure 2D-Jam-Relief greenwave time-offset for every intersections: 1) setup an origin source-intersection of 2D-Jam-Relief greenwave, which is an influx point of 2 cross jammed traffic direction ends, that's, an intersection at a corner of the rectangle area, set one of the 2 directions as master controlled direction and the other as slave controlled direction, their respective reverse directions as master traffic Jam-Relief greenwave direction and slave traffic Jam-Relief direction, meanwhile, set all the source-intersections of the Jam-Relief greenwave of master D-channels in the rectangle area as slave Jam-Relief greenwave time-offset D-channel, that's, a D-channel at the edge in the rectangle area, 2) calculate Jam-Relief greenwave time-offset of every intersection of every master D-channel: the sum of the JVQ-start-time of the road-segments between a source-intersection and one of its downstream intersections as so-called intersection jam-relief greenwave-offset of the downstream intersection in every master jam-relief greenwave D-channel in the rectangle, 3) calculate slave Jam-Relief greenwave time-offset of every intersections in the slave jam-relief greenwave time-offset channel: the sum of the JVQ-start-time of the road-segments between the origin source-intersection and one of its downstream intersections, the source-intersections of master greenwave D-channel along the slave Jam-Relief greenwave direction, 4) add respectively corresponding master/slave two time-offset and set up for every intersection: add its master jam-relief greenwave time-offset in its master channel and its slave jam-relief greenwave time-offset at the source-intersection of its master channel referring to the 2D origin source-intersection along the slave direction;

S3 run RATIO mode after running out respective 2D-Jam-Relief greenwave-offset of an intersection with red light on or without signals;

Another feature of the present invention is that step S1 includes steps of:

S11 Said JVQ-start-time equals to JVQ-start-coefficient*jam-coefficient*the road-segment-length, where the jam-coefficient is less than or equal to one, “equals to one” means that heavy jam occurs, that's, jammed vehicle-queue-length=the road-segment-length;

Another feature of the present invention is that step S1 includes steps of:

S12 Said jammed vehicle-queue-length minus the length of the queue's upstream intersection without any vehicle multiplied by a value less than or equal to one;

Another feature of the present invention is that step S1 includes steps of:

S13 Said queue-length plus the length of the traffic upstream intersection with vehicles fully filled;

Another feature of the present invention is that step S1 includes steps of:

S14 Said JVQ-start-time=JVQ-start-coefficient*jam-coefficient*road-segment-length*apart-coefficient, where the apart-coefficient is bigger than or equal to one, equals to one for keeping present status, “bigger than one” makes the vehicle queue apart from each other;

Another feature of the present invention is that step S3 includes steps of:

S31 Said “running out” mean that decreasing the 2D-Jam-Relief greenwave time-offset second by second to zero;

Another feature of the present invention is that step S3 includes steps of:

S32 Said “running out” or means increasing a value second by second from zero to the set 2D-Jam-Relief greenwave time-offset;

Note1: Said an intersection is a cross of multiple road-segments, controlled by corresponding traffic signals network, 1) a road-segment means a connection section between two adjacent intersections. 2) a channel means multi tandem-connected road-segments, a channel from one side of a roadnet to the other side without intersection-turn is a straight channel, denoted by D-channel;

Note2: Said features of a roadnet includes the amount of intersections controlled, the distance and the JVQ-start-time of road-segments, the distribution of the intersections; a JVQ start-time means the time from when green-lights open to when the most rear vehicle of the wait queue in front of the green-lights start and move; the roadnet with M*N intersections, denoted by {M,N} or {(0,0),(M−1,N−1)}, which (#,#) represents the intersection coordinates, M columns of D-channel, or said M col-D-channels, N rows of D-channel, or said N row-D-channels; column-road-segments denoted Col. {M, N−1} {==}, represents the total number M of columns of D-channels, each col-D-channel including N−1 road-segments, the m-th col-D-channel with the set of the JVQ-start-time of every road-segments of the col-D-channel denoted as col.m{==}, “==” representative for the corresponding values of road-segments of (N−1) columns; row-road-segments denoted Row{N, M−1} {==}, represents the total number N of rows of D-channels, each row-D-channel including M−1 road-segments, the n-th row-D-channel with the set of the JVQ-start-time of every road-segments of the row-D-channel denoted as row n{==}, “==” representative for the corresponding values of road-segments of (M−1) rows; the total number of road-segments at least N*(M−1)+M*(N−1); the values including the length, JVQ-start-time, or, their fixed, etc; it is not a must for absolute parallelism of road-segments.

Note3: Said Jam-Relief greenwave time-offset of intersection is the sum of all road-segments' JVQ-start-time from their source-intersection to one of its downstream intersections in reversed greenwave direction in the set of the JVQ-start-time of a D-channel, denoted by d#{*}, which are from said Col. {M,N−1} {==} or Row {N,M−1} {==} inserted with the JVQ-start-time=0 of column or row for their source-intersection, “d” represents direction of greenwave, N/North, E/East, S/South, W/West, etc, “#” represents coordinates of an intersection, that's, d#{*}=>d(i,j){*}, such as N(6,2) {0,==} represents intersection (6,2) of North-flow greenwave in a roadnet and the most-south (i.e., the reversed North) end intersection as a source-intersection with JVQ-start-time 0, “==” is the set of the JVQ-start-time of the road-segments in the channel; for D-channel, “#” represents serial number of a D-channel, such as W1 {==,0} representing that west-flow greenwave in a roadnet and the most-east (i.e., the reversed west) end intersection as a source-intersection with JVQ-start-time=0 and all the intersections with j=1; well, S4{==,0} representing that south-flow greenwave in a roadnet and the most-north (i.e., the reversed south) end intersection as a source-intersection with JVQ-start-time=0 and all the intersections with i=4.

The advantages of the present invention are below: the calculation and the simulation within a 7×5 roadnet shows that 2D-Jam-Relief greenwave signals mode obtains higher efficient by 50% in relieving heavy traffic jam in a roadnet than 1D-Jam-Relief greenwave mode, by 100% than mode RATIO, greatly improve the efficiency of traffic signal control and traffic.

### BRIEF DESCRIPTION OF THE DRAWINGS

FIG. 1 is a roadnet running a 2D-Jam-Relief greenwave;

FIG. 2 is structure of a roadnet with traffic signal control system and 2D-Jam-Relief greenwave time-offset setting and running;

FIG. 3 shows at 0 second the jammed traffic situation with 2D-Jam-Relief greenwave;

FIG. 4 shows at 135^{th} second the jammed traffic situation with 2D-Jam-Relief greenwave;

FIG. 5 is a flowchart of 2D-Jam-Relief greenwave control method;

### LIST OF REFERENCE NUMERAL UTILIZED IN THE DRAWING

FIG. 1: 1—roadnet, 2—intersection, 3—South-direction 7 jammed traffic channels with North Jam-Relief greenwave, 4—East-direction 5 jammed traffic channels with West Jam-Relief greenwave, 5—East/South direction jammed traffic;

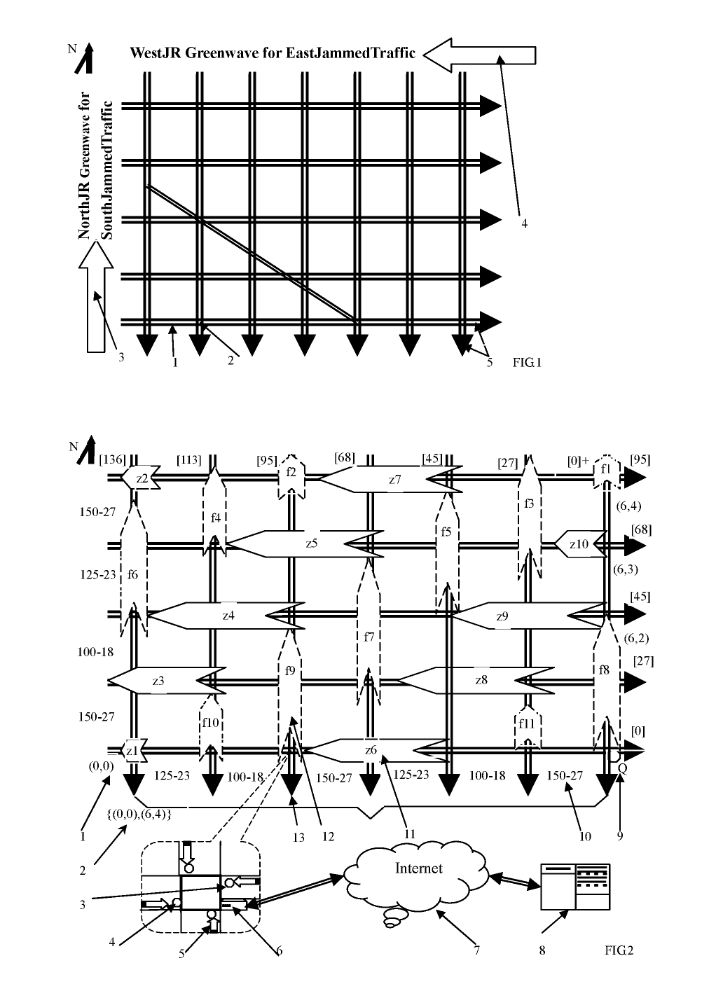

FIG. 2: 1—the origin of roadnet and intersection coordinates with (0,0) at lower-left corner; 2—roadnet mark {(0,0),(6,4)}; 3—intersection; 4—traffic signals; 5—vehicle queue; 6—traffic signals controller; 7—internet; 8—control system center; 9—the origin marked as Q and small octagon and its coordinates(6,0); 10—“#-#” is for two values: the distance between two adjacent intersections, JVQ-start-time, unit: “meter-second/meter”, and JVQ-start-time=JVQ-start-coefficient*jam-coefficient*the distance of the road-segment*apart-coefficient, where jam-coefficient is less than or equal to 1, “equal to 1” mean heavy jam, apart-coefficient is bigger than or equal to 1, “equal to 1” mean “keeping present status”, JVQ-start-coefficients are estimated on experiment range 0.14˜0.22, median value 0.18, with assuming that the jam-coefficient=1 of heavy-jam, queue-length=the distance of the road-segment, apart-coefficient=1 of keeping present status, ignoring the width of intersection, so, the length of road-segment*0.18=JVQ-start-time; ??11—master Jam-Relief greenwave direction signed with solid line arrow pointing at left-west, numbered 6, marked z6, z1 at leftside is a master Jam-Relief greenwave leaving numbered 1, 12—a slave Jam-Relief greenwave numbered 9, marked f9 and dotted line arrow pointing at up-north, f11 is a slave Jam-Relief greenwave numbered 11 just starting and coming in, which is formed from green light off of master Jam-Relief greenwave, the length of the line arrow for master/slave greenwaves represents an estimate of greenwave time, such as the length of f6 representing about 45 seconds, z10 for 12 seconds; 13—jammed traffic, the FIG. 2 shows the greenwave status which runs at 270^{th} second, the numbers in square brackets are Jam-Relief greenwave time-offset of an intersection, where the rows or columns of square brackets corresponds the intersections of master or slave greenwave, from here on, a solid hollow arrow with z stands for master greenwave and its direction, a dotted hollow arrows with f stands for slave greenwave and its direction;

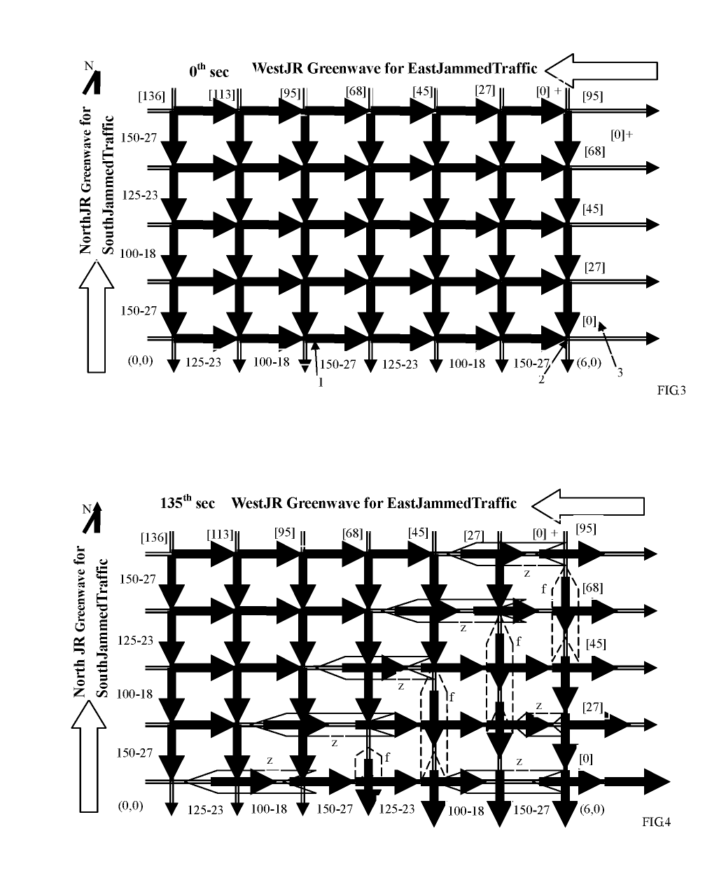

FIG. 3: 1—the 3^{rd} jammed road-segment of the 1^{st} row D-channel, where short black arrow vehicle-jammed road-segment and its direction, in FIG. 3 there are two jammed traffic directions: South and East, along the sides of FIG. 3 two white arrows standing for two cross Jam-Relief greenwave and their directions: North and West, 2—the origin intersection (6,0) of 2D-Jam-Relief greenwave, its time-offset is 0 as the number in its square brackets, 3—the numbers in square brackets are jam-relief greenwave-offset of an intersection, where the rows or columns of square brackets corresponds the intersections of master or slave greenwave: jammed traffic of every road-segment at 0^{th} second of the Jam-Relief greenwave where no traffic can move forward in road-segments, and the black arrows across over two sides of an intersection means part of the traffic in the road-segment have moved forward and the rest have not;

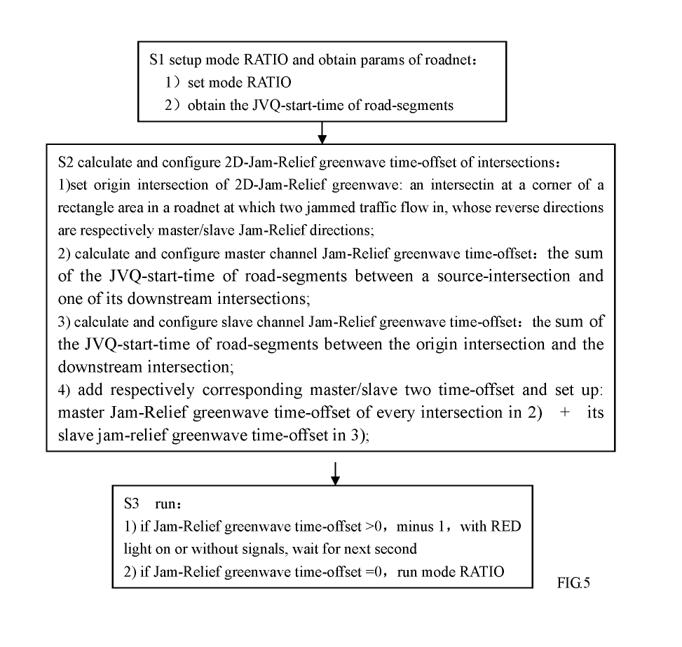

FIG. 4—shows at second 135 of the Jam-Relief greenwave running the traffic situation in the road-segments:

East 1 D-channel, intersection(6,0) are changing into its 2^{nd} slave greenwave South green light just finishing the 45 sec of East green light of its 2^{nd} period of 90 secs due to its 2D-Jam-Relief greenwave time-offset[0+0], intersection(5,0) has run for its [27+0] sec, its 1^{st} period of 90 secs, and its 2^{nd} master greenwave East green light for 18 secs, intersection(4,0) has run for its [45+0], its 1^{st} period of 90 secs, and changing into its 2^{nd} master greenwave East green light, intersection(3,0) has run for its [68+0], its 1^{st} master greenwave East green light of 45 secs, and running its 1^{st} slave greenwave South green light for 22 secs, intersection(2,0) has run for its [95+0], its 1^{st} master greenwave East green light for 40 secs, intersection(1,0) has run for its [113+0], its 1^{st} master greenwave East green light for 22 secs, intersection(0,0) has run for 135 secs of its [136+0], 1 sec to complete its [136+0] for opening its master East greenwave green light;

East 2 D-channel, intersection(6,1) has run for its [0+27], its 1^{st} period of 90 secs, and its 2^{nd} East master greenwave for 18 secs, intersection(5,1) has run for its [27+27] secs, its 1^{st} master greenwave East green light for 45 secs, and its 1^{st} slave greenwave South green light for 36 secs, intersection(4,1) has run for its [45+27], its 1^{st} master greenwave East green light for 45 secs, and its 1^{st} slave greenwave South green light for 18 secs, intersection(3,1) has run for its [68+27], its 1^{st} master greenwave East green light for 40 secs, intersection(2,1) has run for its [95+27], its 1^{st} master greenwave East green light for 13 secs, intersection(1,1) has run for 135 secs of its [113+27], 5 sec to complete its [113+27] for opening its master East greenwave green light;

East 3 D-channel, intersection(6,2) has run for its [0+45], its 1^{st} period of 90 secs, and changing into its 2^{nd} East master greenwave, intersection(5,2) has run for its [27+45] secs, its 1^{st} master greenwave East green light for 45 secs, and its 1^{st} slave greenwave South green light for 18 secs, intersection(4,2) has run for its [45+45], its 1^{st} master greenwave East green light for 45 secs, and changing into its 1^{st} slave greenwave South green light, intersection(3,2) has run for its [68+45], its 1^{st} master greenwave East green light for 22 secs, intersection(2,2) has 5 sec to complete its [95+45] for opening its master East greenwave green light;

East 4 D-channel, intersection(6,3) has run for its [0+68], its 1^{st} master greenwave East green light for 45 secs, and its 1^{st} slave greenwave South green light for 22 sec, intersection(5,3) has run for its [27+68] secs, its 1^{st} master greenwave East green light for 40 secs, intersection(4,3) has run for its [45+68], its 1^{st} master greenwave East green light for 22 secs, intersection(3,3) has 5 sec to complete its [68+68] for opening its master East greenwave green light;

East 5 D-channel, intersection(6,4) has run for its [0+95], its 1^{st} master greenwave East green light for 40 secs, intersection(5,4) has run for its [27+95] secs, its 1^{st} master greenwave East green light for 13 secs, intersection(4,4) has run for 135 sec, has 5 sec to complete its [45+95] for opening its master East greenwave green light;

### DETAILED DESCRIPTION OF THE INVENTION

### Description of the Preferred Embodiments, Industry Applications

A detailed description of an embodiment of the invention in conjunction with the accompanying drawings:

Create a roadnet as shown in FIG. 2: its intersection as label 3, traffic flow as label 5, controlled by straight/left 2 phases traffic signals as label 4 and signal controller as label 6 or equipped with sensors, through internet as label 7 obtaining commands from control center as label 8, the effectiveness of the control as shown in FIG. 3 and FIG. 4, the 2D-Jam-Relief greenwave mode executed as FIG. 5;

In FIG. 2, the features of a roadnet included: the coordinates(0,0) as label 1 of origin intersection at the lower left corner of roadnet {(0,0), (6,4)} or {7,5} as label 2, which has a total of 35 intersections, 7 North-South col.-D-channels and 5 East-West row-D-channels, the set of the JVQ-start-time of the col-D-channels Col. {7,4} {==} for 28 corresponding North-South road-segments, the set of the JVQ-start-time of the row-D-channels Row{5,6} {==} for 30 corresponding East-West road-segments of the row-D-channels, the “#-#” as label 10 for length # and its JVQ-start-time # of each road-segment, unit: meter-second, where the JVQ-start-time=JVQ-start-coefficient*jam-coefficient*road-segment-length*apart-coefficient, wherein jam-coefficient is less than or equal to 1, “equal to 1” means heavy jam, apart-coefficient is bigger than or equal to 1, “equal to 1” means keeping-the-present-status, JVQ-start-coefficient based on experimental estimate ranges 0.14˜0.22, taking their median 0.18, letting jam-coefficient=1, heavy jam, vehicle-queue-length=road-segment-length under heavy-jam, and apart-coefficient=1, keeping-the-present-status, ignoring the length of an intersection, so that JVQ-start-time=road-segment-length*0.18; the set of the JVQ-start-time of the road-segments of East D-channels from East 1 {==} to East 5{==} are {23,18,27,23,18,27}, the set of the JVQ-start-time of the road-segments of South D-channels from South 1 {==} to South 7{==} are {27,18,23,27};

as FIG. 2, configure 2D-Jam-Relief geenwave: select intersection (6,0) by label 9 as a source-intersection of slave Jam-Relief greenwave, i.e., the origin of 2D jam-relief greenwave, master Jam-Relief greenwave direction is West, relieved traffic direction is East, denoted by arrow with z labeled 11, slave Jam-Relief greenwave direction is North denoted by arrow with f labeled 12, relieved traffic direction is South, denoted by black arrow labeled 13, the set of the source-intersections of master Jam-Relief greenwave is col.6{(6,0), (6,1), (6,2), (6,3), (6,4)}, the set of the sum of the JVQ-start-time of the road-segments of master Jam-Relief D-channels from its source-intersection to one of its downstream intersections includes East 1 {*} to East 5 {*} are {136,113,95,68,45,27,0}={23+18+27+23+18+27, 18+27+23+18+27, 27+23+18+27, 23+18+27, 18+27, 27, 0}, wherein the 0 at the most right is inserted into the set of the JVQ-start-time of the road-segments of a master Jam-Relief greenwave channel, the set of the sum of the JVQ-start-time of the road-segments of the slave Jam-Relief greenwave D-channels from its source-intersection, the origin intersection of 2D-Jam-Relief greenwave, to one of its downstream intersections: South 6 {*}={0, 27, 27+18, 27+18+23, 27+18+23+27}={0, 27, 45, 68, 95}, wherein the 0 at the most left is inserted into the set of the JVQ-start-time of the road-segments of a slave Jam-Relief greenwave channel;

In FIG. 5, the control method of 2D-Jam-Relief greenwave comprises the steps of feature:

S1 setup default ratio signal mode: (1) set north as signal main direction for all intersections in a roadnet, cycle=90 seconds, the time ratio for directions=1, each direction 45 seconds, straight/left 2-phase ratio=2, straight phase 30 seconds, left phase 15 seconds; (2) and obtain a rectangle from the roadnet, including 7×5 intersections with 7 col.-D-channels and 5 row-D-channels, and the JVQ-start-time of every road-segment of the channels, JVQ-start-time=JVQ-start-coefficient*jam-coefficient*road-segment-length*apart-coefficient, wherein jam-coefficient is less than or equal to 1, “equal to 1” means heavy jam, apart-coefficient is bigger than or equal to 1, “equal to 1” means keeping-the-present-status, JVQ-start-coefficient based on experimental estimate ranges 0.14˜0.22, taking their median 0.18, letting jam-coefficient=1, heavy jam, vehicle-queue-length=road-segment-length under heavy-jam, and apart-coefficient=1, keeping-the-present-status, ignoring the length of an intersection, so that JVQ-start-time=road-segment-length*0.18; the set of the JVQ-start-time of the road-segments of East D-channels from East 1 {==} to East 5{==} are {23,18,27,23,18,27}, the set of the JVQ-start-time of the road-segments of South D-channels from South 1 {==} to South 7{==} are {27,18,23,27};

S2: calculate and configure the 2D-Jam-Relief greenwave time-offset: 1) setup an intersection at a corner in the rectangle area as an origin of the 2D-Jam-Relief greenwave: that's, intersection(6,0), master/slave Jam-Relief directions: master jammed direction East—slave jammed direction-South, their corresponding master Jam-Relief greenwave direction West—slave Jam-Relief greenwave direction-North, and the set of the source-intersections is col.6{(6,0), (6,1), (6,2), (6,3),(6,4),}, that's, South 6{*}, 2) setup Jam-Relief greenwave time-offset for every intersection of every master greenwave D-channel: the sum of the JVQ-start-time of the road-segments between the source-intersection of a master greenwave D-channel and one of its downstream intersections along their master greenwave direction, 3) calculate Jam-Relief greenwave time-offset of the slave time-offset D-channel, the sum of the JVQ-start-time of the road-segments between the source-intersection, the origin (6,0) of 2D-Jam-Relief greenwave, of the slave time-offset D-channel and one of its downstream intersections along its slave greenwave direction, 4) add the said two time-offset of every intersection: Jam-Relief greenwave time-offset for every intersection of every master greenwave D-channel+Jam-Relief greenwave time-offset of the slave time-offset D-channel, the calculation results are:

Jam-Relief greenwave-time-offset for every intersection of master greenwave D-channel: East 1{*} to East 5{*} are {136,113,95,68,45,27,0},

Jam-Relief greenwave-time-offset of the slave time-offset channel: 1: South 6{*} is {0,27,45,68,95},

the set of 2D-Jam-Relief greenwave time-offset:

East 1{*}={136+0,113+0,95+0,68+0,45+0,27+0,0+0},

East 2{*}={136+27,113+27,95+27,68+27,45+27,27+27,0+27},

East 3{*}={136+45,113+45,95+45,68+45,45+45,27+45,0+45},

East 4{*}={136+68,113+68,95+68,68+68,45+68,27+68,0+68},

East 5{*}={136+95,113+95,95+95,68+95,45+95,27+95,0+95},

Concrete to an intersection, such as the 2D-Jam-Relief greenwave time-offset of the 3^{rd} intersection (2,3) of East 4^{th} D-channel East 4{*} is [95]+[68]=163, the time-offset of the 1^{st} intersection (0,4) of East 5^{th} D-channel East 5{*} is [136]+[95]=231, the time-offset of the origin intersection (6,0) is [0]+[0]=0;

S3: run out the 2D-Jam-Relief geenwave time-offset of each intersection with red signal on or without signal light first, then run RATIO mode, that's: for each intersection, if the 2D-Jam-Relief greenwave-offset >0, display Red signal or no signal, and minus 1, wait for next second, until the 2D-Jam-Relief greenwave time-offset=0, execute mode RATIO.

What is claimed as new and desired to be protected by Letters Patent is set forth in the following:

1. A method for 2-cross-direction traffic jam-relief greenwave in roadnets includes steps:
S1: Initialize signal system as mode RATIO with obtaining the feature parameters of a controlled roadnet, such as a rectangle area of M*N intersections, M columns of D-channels, N rows of D-channels, and the start-time of the jam-vehicle-queues of the road-segments of the D-channels of roadnet, denoted by JVQ-start-time, where the JVQ-start-time equals to JVQ-start-coefficient*queue-length, wherein the JVQ-start-coefficient ranges from 0.14 to 0.22, taking median 0.18, unit: sec/meter, can be dynamically adjustable with the control system;
S2: calculate and configure 2D-Jam-Relief greenwave time-offset for every intersections: 1) setup an origin source-intersection of 2D-Jam-Relief greenwave, which is an influx point of 2 cross jammed traffic direction ends, that's, an intersection at a corner of the rectangle area, set one of the 2 directions as master controlled direction and the other as slave controlled direction, their respective reverse directions as master traffic Jam-Relief greenwave direction and slave traffic Jam-Relief direction, meanwhile, set all the source-intersections of the Jam-Relief greenwave of master D-channels in the rectangle area as slave Jam-Relief greenwave time-offset D-channel, that's, a D-channel at the edge in the rectangle area, 2) calculate Jam-Relief greenwave time-offset of every intersection of every master D-channel: the sum of the JVQ-start-time of the road-segments between a source-intersection and one of its downstream intersections as so-called intersection jam-relief greenwave-offset of the downstream intersection in every master jam-relief greenwave D-channel in the rectangle, 3) calculate slave Jam-Relief greenwave time-offset of every intersections in the slave jam-relief greenwave time-offset channel: the sum of the JVQ-start-time of the road-segments between the origin source-intersection and one of its downstream intersections, the source-intersections of master greenwave D-channel along the slave Jam-Relief greenwave direction, 4) add respectively corresponding master/slave two time-offset and set up for every intersection: add its master jam-relief greenwave time-offset in its master channel and its slave jam-relief greenwave time-offset at the source-intersection of its master channel referring to the 2D origin source-intersection along the slave direction;
S3: run RATIO mode after running out respective 2D-Jam-Relief greenwave-offset of an intersection with red light on or without signals.

2. A method as defined in claim 1, wherein step S1 includes the steps of:
S11: Said JVQ-start-time equals to JVQ-start-coefficient*jam-coefficient*the road-segment-length, where the jam-coefficient is less than or equal to one, “equals to one” means that heavy jam occurs, that's, jammed vehicle-queue-length=the road-segment-length.

3. A method as defined in claim 1, wherein step S1 includes the steps of:
S12: Said jammed vehicle-queue-length minus the length of the queue's upstream intersection without any vehicle multiplied by a value less than or equal to one.

4. A method as defined in claim 1, wherein step S1 includes the steps of:
S13: Said queue-length plus the length of the traffic upstream intersection with vehicles fully filled.

5. A method as defined in claim 1, wherein step S1 includes the steps of:
S14: Said JVQ-start-time=JVQ-start-coefficient*jam-coefficient*road-segment-length*apart-coefficient, where the apart-coefficient is bigger than or equal to one, equals to one for keeping present status, “bigger than one” makes the vehicle queue apart from each other.

6. A method as defined in claim 1, wherein step S3 includes the steps of:
S31: Said “running out” mean that decreasing the 2D-Jam-Relief greenwave time-offset second by second to zero.

7. A method as defined in claim 1, wherein step S3 includes the steps of:
S32: Said “running out” or means increasing a value second by second from zero to the set 2D-Jam-Relief greenwave time-offset.
